(19) United States
(12) Patent Application Publication
(10) Pub. No.: US 2015/0172740 A1
(43) Pub. Date: Jun. 18, 2015

(54) REMOTE CONTROL LOCK

(71) Applicant: Joseph Soto, El Paso, TX (US)

(72) Inventor: Joseph Soto, El Paso, TX (US)

(21) Appl. No.: 14/104,141

(22) Filed: Dec. 12, 2013

(51) Int. Cl. H04N 21/422; H04N 5/44

(52) U.S. Cl. CPC H04N 21/4221; H04N 5/4403

(57) ABSTRACT

A remote control with locking mechanism comprising a housing, where the housing includes a front face and a back face; a plurality of buttons on the front face of the housing, where the plurality of buttons operate a plurality of functions on the remote control; and a remote control lock on the housing, where the remote control lock inactivates the plurality of buttons. The remote control lock is positioned on the back face of the housing to prevent accidental pressing. The remote control lock includes an LED light to indicate when the remote control lock is in operation.

### BACKGROUND OF THE INVENTION

1. Field of the Invention

The present invention relates to a lock button incorporated into a remote control to prevent unintentional button pressing when watching a movie or television.

2. Description of Related Art

Many gaming consoles are able to function as more than a gaming device; they are total entertainment systems. The consoles are able to play games, videos, music, and browse the internet. Many apps are available for use on the console which enables the user to stream movies, TV shows, and athletic events. A plethora of entertainment is available to the user right at their fingertips.

The same controller used while gaming is also used to navigate through the various options for the movie, music and internet. Even non gamers are able to easily learn how to use the gaming controller to watch their shows. While it is easy to operate the controller it is also easy to inadvertently hit one or more buttons. The buttons are designed to be sensitive to where even slight pressing controls a movement in the game. Therefore slightly pressing the buttons causes an operational change during the movie. This may cause a range of disruptions from stopping or fast forwarding the movie, going to a home screen, presenting different episodes to watch or even turning off the console itself. This is bothersome and annoying to the user having to repeatedly go back to where they were in the movie.

It would be beneficial in the art to provide a way for a user to prevent the buttons from changing when watching a movie. It would also be desirable in the art for the controller to easily switch from operational to nonoperational as needed by the user.

### SUMMARY OF THE INVENTION

In view of the foregoing disadvantages inherent in the prior art, the general purpose of the present invention is to provide a lock incorporated into a remote control, configured to include all of the advantages of the prior art, and to overcome the drawbacks inherent therein.

Accordingly, an object of the present invention is to provide a remote control with a lock to prevent the keys from operating.

Another object of the present invention is to provide a remote control lock with a light to indicate when the lock is functioning and when it is off.

To achieve the above objects, in an aspect of the present invention, a remote control with locking mechanism is described comprising a housing, where the housing includes a front face and a back face; a plurality of buttons on the front face of the housing, where the plurality of buttons operate a plurality of functions on the remote control; and a remote control lock on the housing, where the remote control lock inactivates the plurality of buttons. The remote control lock is positioned on the back face of the housing to prevent accidental pressing. The remote control lock includes an LED light to indicate when the remote control lock is in operation.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 (A) depicts a front side view of a remote control in accordance with an exemplary embodiment of the present invention; and

FIG. 1 (B) depicts a back side view of a remote control in accordance with an exemplary embodiment of the present invention.

Like reference numerals refer to like parts throughout the description of several views of the drawings.

### DETAILED DESCRIPTION OF THE DRAWINGS

The present invention relates to a lock button incorporated into a remote control to prevent unintentional button pressing when watching a movie or television. The present invention provides a remote control lock to shut down the functions of the buttons on a gaming or television remote control to allow the user to watch their movie or program without controller disruptions. Preferably the remote control lock is positioned on a part of the remote away from the other buttons to ensure that the lock is not accidentally pressed. The remote control lock may be incorporated into a variety of remote controls like for gaming consoles, televisions, sound systems and the like.

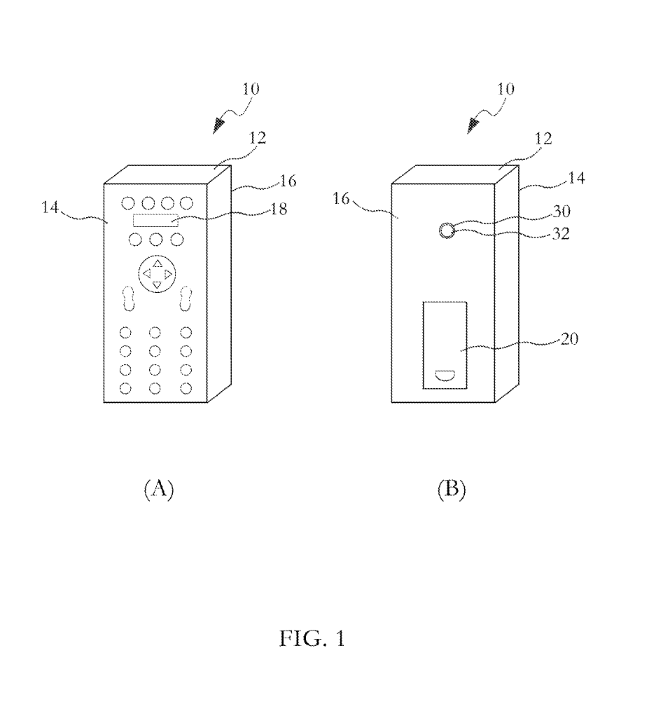

Turning now descriptively to the drawings, referring to FIG. 1, a front side view of a remote control 10 is shown in accordance with an exemplary embodiment of the present invention. The remote control 10 includes a housing 12, where the housing 12 includes a front face 14 and a back face 16. On the front face 14 are a plurality of buttons 18. The plurality of buttons 18 control the operating functions of the remote control 10 which in turn controls the functions of a device. The remote control 10 is illustrated as a standard rectangular remote for a television, audio system, cable box, DVD, Blu-ray® or other entertainment operating system. The remote control 10 may also be embodied as a gaming controller for use with gaming consoles like an Xbox®, PlayStation®, or Wii®.

Referring to FIG. 1(B) a back side of the remote control 10 is shown in accordance with an exemplary embodiment of the present invention. The remote control 10 may include a battery compartment 20 to house one or more batteries. Near the battery compartment 20 may be a remote control lock 30. The remote control lock 30 may be positioned on the back face to prevent accidental use. The remote control lock 30 may be a button or a switch to inactivate the functions of the plurality of buttons 18 on the front face of the remote control 10. The remote control lock 30 may include an LED light 32 to indicate to a user when the lock 30 is in use. The LED light 32 may surround the remote control lock 30 (as shown). Alternatively, the LED light 32 may be incorporated into the lock 30 itself so that the remote control lock 30 lights up when in use.

The LED light 32 may illuminate a RED/GREEN light. When the remote control lock 30 is not is use or inactive the LED light 32 may be green. The green light may turn off after a predetermined amount of time to not waste battery life. When the remote control lock 30 is in use or active the LED light 32 may be red. This way the user knows they have to press the remote control lock 30 to unlock the plurality of buttons 18. The plurality of buttons 18 may cause the red LED light 32 to illuminate when the remote control lock 30 is active to indicate to the user that the buttons 18 are locked and that they must press the remote control lock 30 again to unlock them. By incorporating the remote control lock 30 into a remote control the user is assured that their entertainment enjoyment will not be interrupted. The LED light 32 provides additional convenience to indicate to the user when the remote control lock 30 is in use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A remote control with locking mechanism comprising;
a. a housing, where the housing includes a front face and a back face;
b. a plurality of buttons on the front face of the housing, where the plurality of buttons operate a plurality of functions on the remote control; and
c. a remote control lock on the housing, where the remote control lock inactivates the plurality of buttons.

2. The remote control with locking mechanism according to claim 1, where the remote control lock is positioned on the back face of the housing.

3. The remote control with locking mechanism according to claim 1, where the remote control lock includes an LED light to indicate when the remote control lock is operating.

4. The remote control with locking mechanism according to claim 3, where the LED light illuminates red and green.

5. The remote control with locking mechanism according to claim 4, where the LED light illuminates red when the remote control lock is active, and where the LED light illuminates green when the remote control lock is inactive.

6. The remote control with locking mechanism according to claim 1, where the remote control lock is a button.

7. The remote control with locking mechanism according to claim 1, where the remote control lock is a switch.

8. The remote control with locking mechanism according to claim 1, where the remote control is a gaming controller.

9. The remote control with locking mechanism according to claim 8, where the gaming controller controls one of at least an Xbox®, a PlayStation® and a Wii®.
